(19) United States
(12) Patent Application Publication
(10) Pub. No.: US 2026/0220416 A1
(43) Pub. Date: Jul. 30, 2026

(54) Credit Card Overlay Having A Bling Effect

(71) Applicant: Manuela Alejandra Da Silva Rodrigues, Fort Lauderdale, FL (US)

(72) Inventor: Manuela Alejandra Da Silva Rodrigues, Fort Lauderdale, FL (US)

(21) Appl. No.: 19/577,982

(22) Filed: Mar. 25, 2026

Related U.S. Application Data
(63) Continuation-in-part of application No. 18/914,852, filed on Oct. 14, 2024.
(60) Provisional application No. 63/578,909, filed on Aug. 25, 2023.

(51) Int. Cl. G06K 19/077

(52) U.S. Cl. CPC G06K 19/07716

(57) ABSTRACT

A credit card overlay for application to a credit card or other similar plastic card which provides a plastic card with a bling effect when the overlay is applied. The bling appearance is achieved by using a vinyl material such as multi-layer vinyl materials used in the manufacture of vinyl car wrap. The overlay may include an opening to expose the chip embedded in the credit card, or may be a solid overlap for use with contactless pay technology. The overlay can be in the form of a substrate having a rhinestone layer or can be imprinted with an image having a bejeweled design.

### CROSS-REFERENCE TO RELATED APPLICATIONS

This application is a continuation-in-part of U.S. Patent Application 18/914,852, filed October 14, 2024, claiming priority therefrom, which claims the benefit of priority from U.S. Provisional Patent Application 63/578,909, filed August 25, 2023.

### FIELD OF INVENTION

The present invention relates to customizable credit card overlays, sometimes referred to as credit card skins. More particularly, the present invention relates to customizable credit card overlays having a “bling” appearance in the form of a bejeweled or bedazzled overlay composed of vinyl material. The credit card overlay can be configured with an opening to expose the credit card chip for use with chip reading payment devices or the credit card overlay can be a complete covering for use with the “tap” payment devices.

### BACKGROUND OF THE INVENTION

Credit cards are widely used as financial instruments. Standard credit cards typically have a uniform appearance, some with the name or logo of a financial institution imprinted thereon. Individuals have sought to personalize or enhance the aesthetic appeal of their credit cards with the use of customizable skins or overlays. Such skins being imprinted with a sports logo, a favorite cartoon character, an iconic celebrity, and the like. Existing credit card cover, skins, and overlays have certain limitations in the durability, design options and/or ease of application and removal. Skins or overlays have been developed which are adherable covers for credit cards, debit cards, gift cards, and similarly sized plastic cards. The conventional credit card skin or overlay is in the form of a “sticker” composed of a thin and smooth thermoplastic material having a design imprinted thereon. Typically, these credit card skins can be adhered to a credit card and can be peeled off at a time when the card skin no longer is desired.

A significant drawback to the thin, thermoplastic type of credit card skin is it incapable of providing a “bling” appearance. A “bling” appearance is a shiny, flashy, and dazzling look, often multi-colored, which can reflect and sparkle in ambient light. A “bling” appearance also includes a bejeweled skin which reflects like and provides the sparkle and dazzle effect. To achieve this “bling” effect, it has been discovered that the use of vinyl car wrap, sometimes referred to as vehicle wrap, a multi-layer film that can be applied to the exterior surface of the car to change its appearance, is an excellent material for attaining a bling effect. The film comprises a vinyl substrate base layer having an upper surface, and undersurface, a protective layer applied to the upper surface and an adhesive layer applied to the undersurface. Typically, a release film is applied to the adhesive layer.

The vinyl substrate can be created in a variety of colors, designs, and textures with matte, glossy and metallic finishes. The adhesive layer used may be a pressure sensitive adhesive (PSA) enabling the vinyl wrap to be applied to a surface with only pressure. The vinyl substrate can be a cast vinyl material or a calendered vinyl material, the difference between these two types of materials is the manner of manufacture. A cast vinyl is created in a liquid state and cast into a sheet or form and processed through ovens, evaporating solvents in the liquid. As the solvents evaporate, the resultant product is a solid film having a thickness measured in micrometers in the range from about 51µm to about 100µm for a solid color. Calendered vinyl film is manufactured by mixing a PVC resin with plasticizers, stabilizers and colorants and heating into molten dough-like mixture, fluxed in a kneader and passed through a series of heated calenders which compress the material into a thin, uniform sheet which is cooled, optionally embossed, and wound. Later an adhesive layer may be applied. Calendered vinyl film is more economical to produce and is best for flat surfaces as it is characterized as being less flexible than a cast vinyl.

In summary, the core components of an automotive vinyl wrap include (1) a PVC substrate having plasticizers, UV inhibitors and heat stabilizing additive, (2) pigments and inks to provide a desired color, metallic look or custom graphic, (3) a pressure-sensitive adhesive on the underside of the substrate, and (4) a release liner such as a paper or plastic backing to protect the adhesive prior to use. Optionally, a top protective layer or overlaminate may be applied to the top surface of the substrate to provide an enhanced finish. The overlaminate typically is a clear, durable coating designed to protect the vinyl wrap from UV rays, scratches, chemical contaminants, and minor abrasions. The PVC substrate defines the color, texture, and finish of the wrap. By using a vinyl substrate, the pigments and ink used in the calendering process can result in a metallic appearance which is shiny, reflective, and sparkling, thus rendering the overlay with a “bling” appearance.

### SUMMARY OF THE INVENTION

The invention of the present subject matter relates to a plastic card skin, such as a credit card overlay comprising a cast or calendered vinyl substrate having an upper surface and an undersurface. The undersurface is provided with an adhesive layer upon which a release layer is disposed. The vinyl substrate may be manufactured with certain pigments, colorants, and very fine particulate materials to provide a textured finish, having the touch or feel of fine sandpaper. In another embodiment, ornamental elements may be applied to the upper surface of the vinyl substrate. In another embodiment, an image or design may be applied to the upper surface of the vinyl substrate. A protective layer typically is applied to the outermost top surface. Because of the relative thickness of the vinyl overlay, UV printer technology is used for wet laser printing onto the substrate, blasting film dye, and curing the dye with UV light. Conventional printing processes used for the conventional thin credit card overlays cannot be used with the vinyl substrate to create the bling effect.

Accordingly, it is an object of the present subject matter to provide an improved credit card customization solution that utilizes a multi-layer vinyl car wrap material upon which an image can be imprinted using a UV printer and wet laser technology for printing onto the substrate, blasting a film dye image thereupon, and curing the dye with UV light, to create a customized credit card overlay.

It also is an object of the present subject matter to provide an improved credit card customization solution that offers the user with enhanced aesthetics to create an overlay which reflects ambient light and sparkles to create a bling effect.

It is another object of the present subject matter to provide a credit card overlay that is created with a vinyl car wrap material to provide the overlay with a bling effect.

It is still another object of the present subject matter to provide a credit card overlay that has a rhinestone-containing upper surface.

It is a yet another object of the present subject matter to provide a credit card overlay that is created with a vinyl car wrap material which covers the entire top surface of a plastic card.

It is a further object of the present subject matter to provide a credit card overlay that is created with a vinyl car wrap material comprising an opening to provide access to a credit card chip.

It is yet a further object of the present subject matter to provide a credit card overlay that is created with a vinyl car wrap material comprising an opening to provide access to a credit card chip wherein the opening is in the form of a square opening corresponding to the size of the credit card chip.

It is still a further object of the present subject matter to provide a credit card overlay that is created with a vinyl car wrap material comprising an opening to provide access to a credit card chip wherein the opening is heart-shaped.

It is an additional object of the present subject matter to provide a credit card overlay that is created with a vinyl car wrap material comprising an opening to provide access to a credit card chip and which further comprises at least one side having at least one fin or tab.

These and other objects of the present subject matter are achieved by providing a multi-layer credit card overlay having a vinyl substrate, a method of customizing a credit card including selecting a design for a credit card overlay, removing a release layer protecting an adhesive layer, aligning the overlay to the surface of a credit card such that the adhesive layer contacts the surface of the credit card, and pressing the overlay onto the credit card to adhere the overlay to the card surface. The present subject matter may further comprise a system for designing the credit card overlay using a design software interface, the system including a canvas area for creating overlay layouts and having tool options for manipulating and imprinting design elements. The credit card overlay of the present subject matter may be in the form of a kit having application instructions and a removal tool.

### BRIEF DESCRIPTION OF DRAWINGS

FIG. 1 illustrates the credit card overlay of the present subject matter having a textured sparkling vinyl surface and a square-shaped opening exposing an embedded a credit card chip.

FIG. 2 illustrates the credit card overlay of the present subject matter having a textured vinyl surface with decorated elements imprinted thereon and a heart-shaped opening exposing an embedded credit card chip.

FIG. 3 illustrates the credit card overlay of the present subject matter having a silvery glittered textured vinyl surface and a design element imprinted thereon and a crown-shaped opening exposing a credit card chip.

FIG. 4 illustrates the credit card overlay of the present subject matter having a textured vinyl surface with a decorative leopard spotted image imprinted thereon and a leopard spot opening exposing a credit card chip

FIG. 5 illustrates the credit card overlay of the present subject matter having a textured sparkling vinyl surface with no cut-out opening for accessing a credit card chip.

FIG. 6 illustrates the credit card overlap of the present subject matter having a textured vinyl surface with bejeweled elements imprinted thereon and no cut-out opening for accessing a credit card chip.

FIG. 7 illustrates an embodiment of the credit card overlay of the present subject matter comprising a multi-layer vinyl car material.

FIG. 8 shows a design software interface for creating the credit card overlays of the present subject matter.

FIG. 9 shows a UV printing device adapted for making the credit card overlays of the present subject matter.

FIG. 10 illustrates the credit card overlay of the present subject matter having an upper surface composed of a rhinestone substrate.

FIG. 11 illustrates the credit card overlay of the present subject matter having an upper surface composed of a rhinestone substrate having design elements therein.

It is to be understood that the drawings are not necessarily to scale. Rather, the drawings are merely representations, not intended to portray specific parameters of the present subject matter unless specified otherwise. The drawings are intended to depict exemplary embodiments of the present subject matter, and therefor should not be considered limiting in scope. In the drawings, like numbering represents like elements. Further, certain elements in some figures may be omitted, or not illustrated to scale, for illustrative clarity. Any cross-sectional views may be in the form of “slices”, or “near-sighted” cross-sectional views, omitting certain background lines that may otherwise be visible in a “true” cross-sectional view, for illustrative clarity. In some instances, where multiple elements are present, only a single element may be labeled or multiple elements may have the same label to indicate that the label applies to all elements of the same type.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “skin,” “overlay,” “cover,” “credit card skin,” “credit card overlay,”, “credit card cover,” derivatives thereof, and similar terms may be used throughout the specification and it is to be understood that such terms are interchangeable and all refer to the credit card overlay having a bling effect of the present subject matter.

Also, it is to be understood that the phraseology and terminology used herein is for the purpose of description and should not be regarded as limiting. The use of the terms "including", "comprising", "having", and variations thereof herein is meant to encompass the items listed thereafter and equivalents thereof as well as additional items.

Reference throughout this specification to “one embodiment” or “an embodiment” means that a particular feature, structure, or characteristic described in connection with the embodiment is included in at least one embodiment. Thus, the use of the phrases “in one embodiment” or “in an embodiment” throughout the specification are not necessarily referring to the same embodiment. Further, particular features, structures, or characteristics may be combined in any suitable manner in one or more embodiments. Headings provided herein are for convenience only and do not interpret the scope or meaning of the claimed invention. The present disclosure is directed to overcoming or at least reducing the effects of one or more of the problems presented above.

The present subject matter is directed credit card overlay which is manufactured to create a bling effect when the overlay is applied to a credit card or other plastic card. The bling appearance is achieved by using a vinyl material such as the material used in the manufacture of vinyl car wrap. The vinyl material may be either a cast vinyl material or a calendered vinyl material, the latter being a preferred embodiment. Using a vinyl substrate as a preferred material for making the customizable overlay in the present invention, the resulting overlay is significantly thicker than the typical material commonly utilized in such applications, about two to three times thicker. In one embodiment, the thickness of the vinyl substrate is in the range from about 51µm to about 100µm. Further, the vinyl material has a unique texture similar to the touch of sandpaper, enabling the overlay to shine and reflect light off of the textured material, thereby creating a bling effect. Because the vinyl material is thick and textured, traditional printing methods for credit card skins cannot be used. It has been discovered that a UV printer can be used to imprint a design on the vinyl substrate, cure the design, and print the design on a vinyl material sheet. The sheet is then cut to create individual credit card covers sized for the standard credit card.

The vinyl substrate may be manufactured with certain pigments, colorants, and very fine particulate materials to provide a textured finish, having the touch or feel of fine sandpaper. In one embodiment, the vinyl substrate may have a matte, glossy, or metallic finish. In another embodiment, ornamental elements may be applied to the upper surface of the vinyl substrate. In another embodiment, an image or design may be applied to the upper surface of the vinyl substrate. A protective layer typically is applied to the outermost top surface. Because of the relative thickness of the vinyl overlay, UV printer technology is used for wet laser printing onto the substrate, blasting film dye, and curing the dye with UV light.

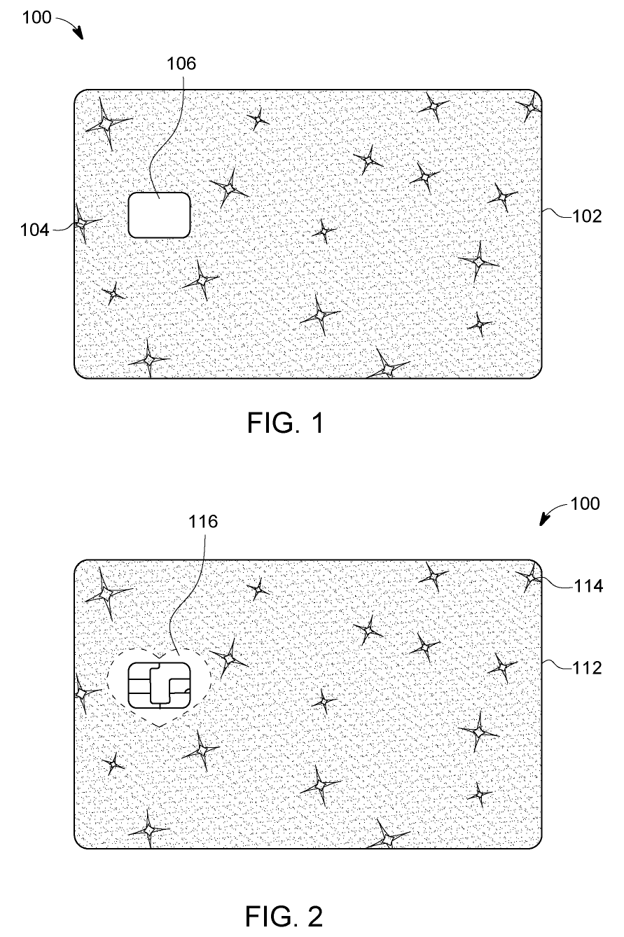

FIG. 1 illustrates a credit card overlay 100 in the form of a vinyl substrate 102 having an upper surface 104 and an opening 106 adapted to expose a credit card chip embedded in a credit card, the opening 106 being dimensioned to the size of the embedded chip. The upper surface 104 is textured such that it gives off a glittery appearance, thereby providing the bling effect. FIG. 2 illustrates an embodiment of a credit card overlay 100 comprising a vinyl substrate 112 having an upper surface 114 and a heart-shaped opening adapted to expose a chip embedded in a credit card. In this embodiment, the textured surface has a different glittery design imprinted thereon. The upper surface 114 may comprise a plurality of reflective particles to create the glittery bling effect.

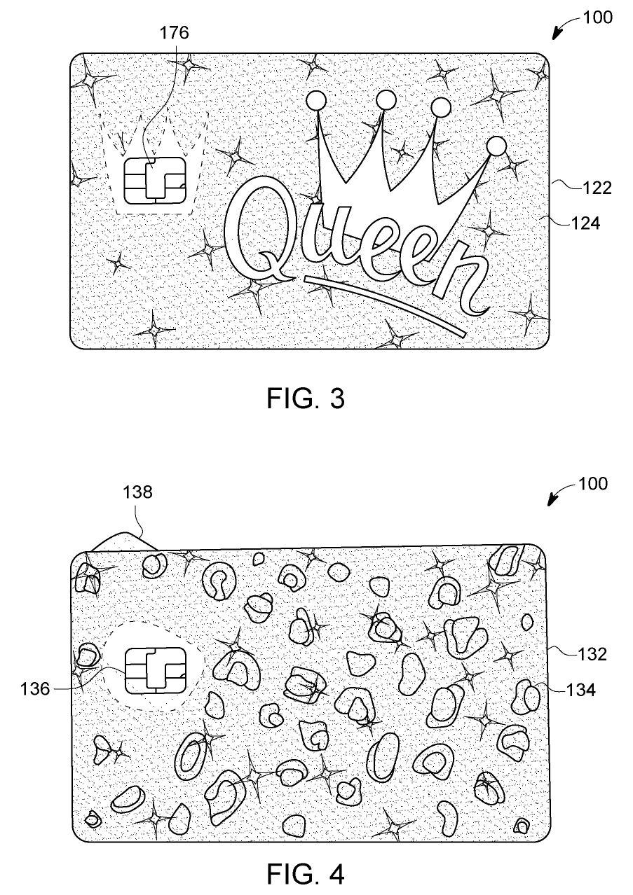

FIG. 3 depicts the credit card overlay 100 of the present subject matter comprising a vinyl substrate 122, silvery glittered textured upper surface 124 having an imprinted image 128 in the form of a crown and the text Queen. In this embodiment, the opening 126 is in the form of a crown and adapted to expose a chip embedded in a credit card. The upper surface 124 further may comprise faceted and reflective particles to achieved the desired bling effect.

FIG. 4 depicts the credit overlay 100 comprising a vinyl substrate 132 having a leopard print image imprinted on the textured upper surface 134, with the opening 136 adapted to expose a chip embedded in a credit card being in the form of a leopard spot. The color of the textured upper surface can be imitative of the color of a leopard, or can be provided with one or more hues. This credit card overlay further comprises a tab or fin 138 extending from the upper edge 133 of the vinyl substrate, the tab or fin 138 may be created as part of the vinyl substrate, may have the same textured upper surface, and may be provided with a crease to fold the tab for storage in a wallet or similar holder for credit cards. It will be obvious to those skilled in the art that although tab or fin 138 is shown extending from the upper edge 133 of the card, the tab may extend from at least one of the side edges 135 of the credit card overlay.

The credit card overlay is designed to correspond to the dimensions of a standard credit card, gift card, and similar cards. In some embodiments as described above, the overlay is provided with an opening to expose a chip embedded in a credit card for access to chip-reading payment devices. In other embodiments, the overlay does not include any cutouts or transparent windows and is configured for contactless payment devices where the credit card is “tapped” to the corresponding contactless symbol.

When the credit card overlay of the present invention is removably adhered to the top surface of a credit card, it transforms the standard credit card to a personalized, customized, eye-catching accessory having a bling effect. The textured and reflective surface finish of the overlay provides both a visual appeal as well as an improved grip. The durable vinyl substrate also protects the credit card from wear-and-tear and minor damage.

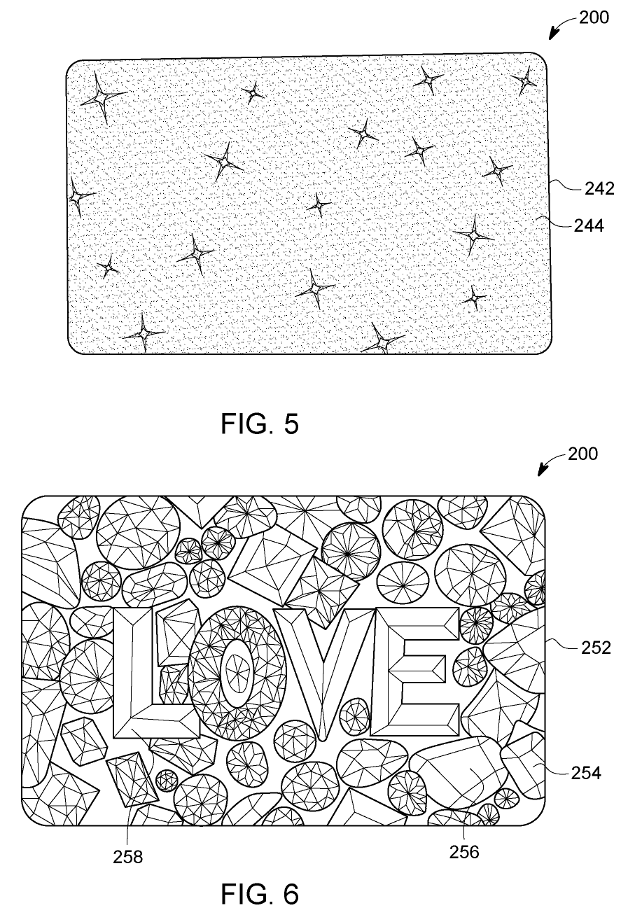

FIG. 5 depicts a credit card overlay 200 comprising a vinyl substrate 242 having a textured surface 144 which sparkles in the reflection of light. The credit card overlay 200 does not have an opening for an embedded chip. Rather, this credit card overlay is adapted for contactless payment, using NFC technology for “tapping” the credit card with a credit card payment device having the required contactless symbol.

FIG. 6 depicts a credit card overlay 200 comprising a vinyl substrate 252 having a textured surface 254 having an image of dazzling jewels 256 imprinted on the upper textured surface 254. The image may further include text 258, such as the word “LOVE”. This credit card overlay 200 also is ideal for the contactless payment technology.

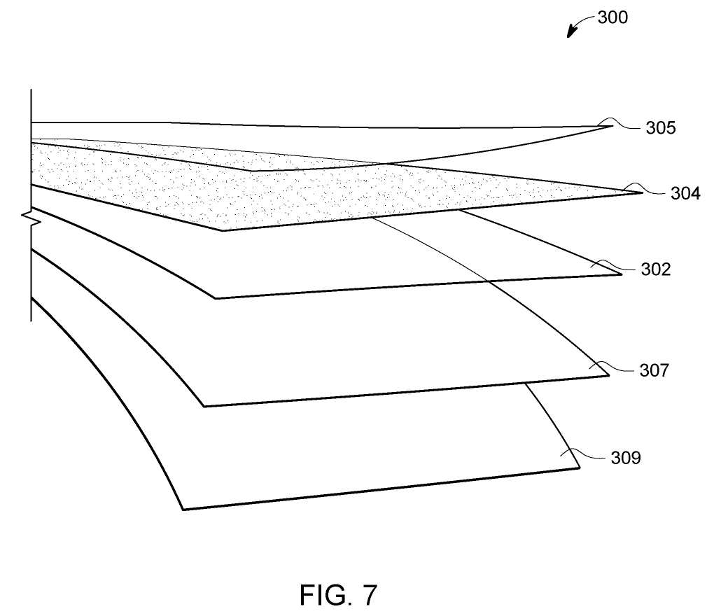

The credit card overlay of the present subject matter can be in the form of a multi-layer structure to provide both functionality and the desired bling effect. Referring now to FIG. 7, a credit card overlay 300 is shown having a vinyl substrate 302, an upper surface 304 which can be textured and adapted to have at least one design imprinted thereon, a wear-resistant top layer 305 to protect the upper surface 304, an adhesive layer 307 on the underside of the vinyl substrate and a release layer 309 to protect the adhesive layer until it is used. The wear-resistant top layer, which is the uppermost layer, protects against scratches and abrasion during normal use.

The vinyl substrate layer can be composed of a cast vinyl material or a calendered vinyl material. The vinyl material inherently is thicker than the traditional credit card skins, thereby giving the credit card overlay of the present subject matter more durability and texture. The increased thickness also provides a substrate capable of having three-dimensional features to be incorporated into the upper surface 304 of the substrate 302 overlay.

The adhesive layer 307 is applied to the underside of the bottom layer. The adhesive material is formulated to allow the credit card overlay to be removable secured to the surface of a credit card and by removed without leaving a residue. In a preferred embodiment, the adhesive material is a pressure-sensitive adhesive such that the overlay can be aligned over the credit card and pressed and removably secured to the card. The removable release layer 309 covers the adhesive layer 307 prior to application, thereby protecting the adhesive layer until the user is ready to apply the overlay to the credit card.

The overlay may be manufactured through a multi-step process. The vinyl substrate first is prepared with the desired thickness, at least one ink and/or pigment to produce customized base color having a metallic look or custom graphic at least as well as plasticizers, UV inhibitors, and at least one heat stabilizing additive. A design, image, or both a design and image then is imprinted. In one embodiment, abrasive particles, such as tiny reflective particles, can be applied to the upper layer 304 by embossing or embedding techniques. The wear-resistant top layer then is laminated to the upper surface layer. The adhesive layer is applied to the underside of the vinyl substrate followed by the application of the release layer.

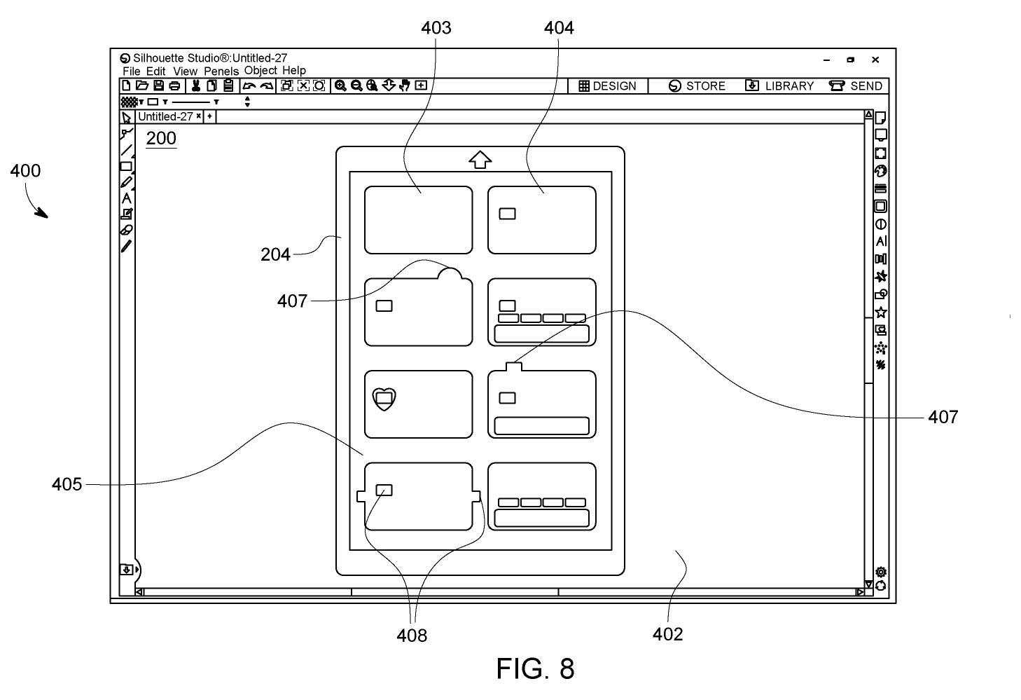

Referring now to FIG. 8, the credit card overlay having a bling effect of the present subject matter can be manufactured using a design software interface 400 comprising a canvas area 402 for designing multiple overlay layouts including the overlay 403 having no opening and the overlay 404 having the traditional square opening for exposing an embedded credit card chip. Of course, it is to be understood that this design software interface may be configured with other overlays including a heart-shaped opening 405, and/or tabs and fins, such as tab 407 and fins 408.

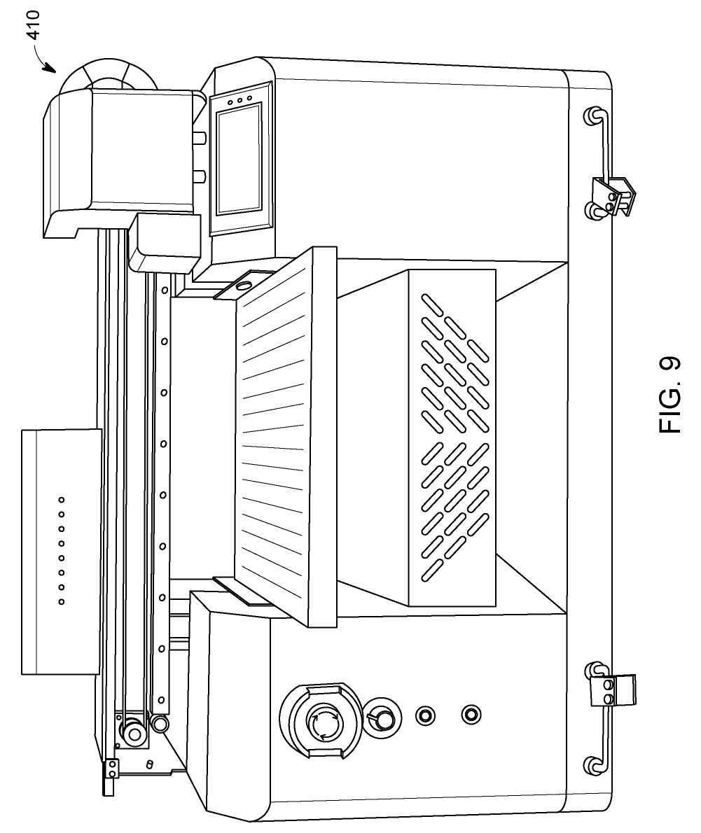

Custom designs or pattens may be printed on the credit card overlay of the present subject matter using UV printing techniques, such as the UV printer Jucolor A3 model 410 shown in FIG. 9. This type of printer is configured to produce vibrant, durable printing directly onto the textured surface of the upper surface of the credit card overlay. In addition, such printing techniques enable a wide range of customization options beyond a sparkly textured surface, further enhancing the bling effect of the credit card overlay of the present invention.

The credit card overlay is designed to correspond to the dimensions of a standard credit card, gift card, and similar cards. In some embodiments, the overlay is provided with an opening to expose a chip embedded in a credit card for access to chip-reading payment devices. In other embodiments, the overlay does not include any cutouts or transparent windows and is configured for contactless payment devices where the credit card is “tapped” to the corresponding contactless symbol.

When the credit card overlay of the present invention is removably adhered to the top surface of a credit card, it transforms the standard credit card to a personalized, customized, eye-catching accessory having a bling effect. The textured and reflective surface finish of the overlay provides both a visual appeal as well as an improved grip. The durable vinyl substrate also protects the credit card from wear-and-tear and minor damage.

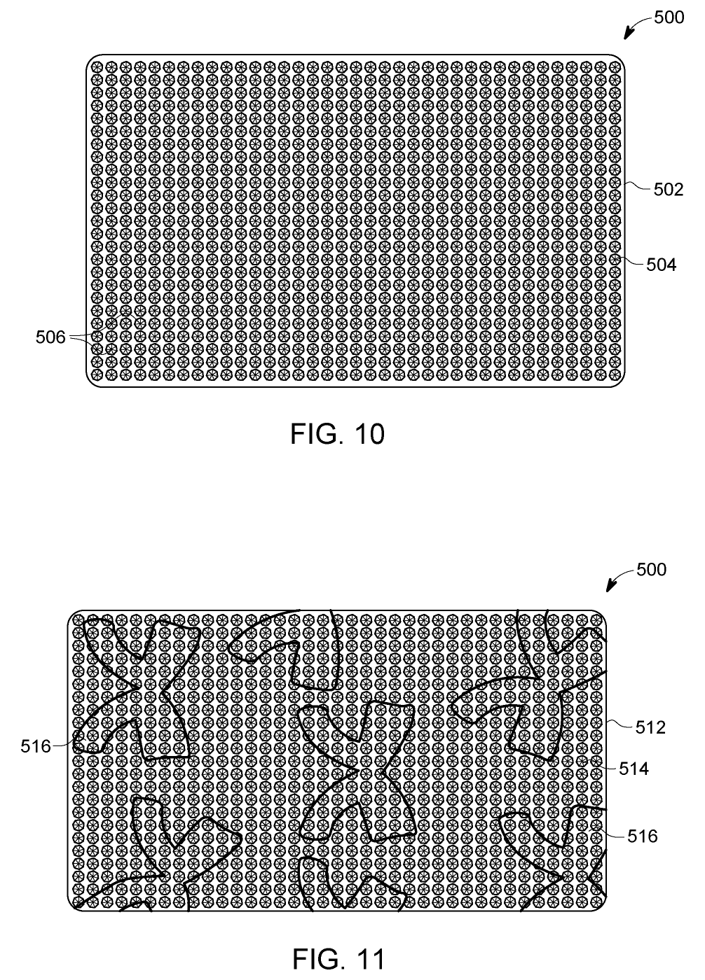

In one embodiment, the credit card overlay of the present subject matter can be in the form of a substrate having a top surface comprising a plurality of rhinestones. As shown in FIG. 10, a credit card overlay 500 is shown having a substrate 502 with an upper surface 504 composed of rhinestones 506. The size and shape of the rhinestones may be uniform or may be varied. Referring now to FIG. 11, the credit card overlay 500 is depicted comprising a substrate 512 having an upper surface 514 composed of rhinestones in a particular pattern 516. The underside of the substrate is provided with a removable adhesive material, such as a pressure-sensitive adhesive. A removable release layer is applied to the adhesive layer until is ready to be applied to the credit card.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C §112, sixth paragraph, unless the element is expressly recited using the phrase “means for. . .” and no method or process step herein is to be construed under those provisions unless the step, or steps, are expressly recited using the phrase "step(s) for. . ..”

1. A credit card overlay comprising a vinyl substrate base layer having an upper surface and an undersurface, said upper surface being in the form of a textured upper surface customized to reflect and sparkle in ambient light, said textured surface having a finish selected from the group consisting of matte, glossy, and metallic finishes and said undersurface having a pressure sensitive adhesive applied thereto, said credit card overlay adapted to be removably adhered to a credit card by aligning said overlay over a credit card and pressing said overlay onto the credit card, wherein when said overlay is removably adhered to a credit card, said textured upper surface creates a bling appearance to the credit card.

2. The credit card overlay in accordance with claim 1, wherein said overlay further comprises a removable release layer applied to said pressure sensitive adhesive.

3. The credit card overlay in accordance with claim 1, wherein said vinyl substrate base layer has a thickness in the range of from about 51µm to about 100µm.

4. The credit card overlay in accordance with claim 1, wherein said vinyl substrate base layer is a polyvinyl chloride (PVC) substrate comprising plasticizers, UV inhibitors, and heat stabilizing additives, and at least one colorant to provide the textured upper surface with a bling effect having a sparkling, colored appearance.

5. The credit card overlay in accordance with claim 4, wherein said vinyl substrate base layer further comprises at least one very fine particulate material to provide the textured upper surface with a bling effect having a sparking, metallic appearance.

6. The credit card overlay in accordance with claim 4, wherein said textured upper surface further is imprinted with an image.

7. The credit card overlay in accordance with claim 5, wherein said textured upper surface further is imprinted with an image.

8. The credit card overlay in accordance with claim 4, wherein said vinyl substrate base layer is selected from the group consisting of cast vinyl material and calendered vinyl material.

9. The credit card overlay in accordance with claim 4, further comprising an opening configured to provide access to a chip embedded in a credit card.

10. The credit card overlay in accordance with claim 9, wherein said opening is configured with the same dimensions as a chip embedded in a credit card.

11. The credit card overlay in accordance with claim 9, wherein said opening is heart-shaped.

12. The credit card overlay in accordance with claim 4, wherein said image imprinted onto said textured upper surface is created by blasting a film dye image onto said textured upper surface and curing said dye image with UV light using a UV printer and wet laser technology.

13. A credit card overlay adapted to be removably adhered to a credit card to provide a credit card with a bling appearance in the form of a multi-layer material comprising a vinyl substrate base layer having an upper surface and an undersurface, said base layer composed of polyvinyl chloride mixed with plasticizers, stabilizers, and colorants, a textured surface layer on said upper surface of said vinyl substrate, a protective layer applied over said textured surface, a pressure-sensitive adhesive layer applied to said undersurface of said base layer, and a release layer applied said pressure-sensitive adhesive layer, said overlay having a thickness in the range of from about 51µm to about 100µm.

14. A credit card overlay adapted to be removably adhered to a credit card to provide a credit card with a bling appearance, said overlay having a substrate layer having an upper surface and an undersurface, a rhinestone layer applied to said upper surface, and an adhesive layer applied to said undersurface.

15. The credit card overlay in accordance with claim 14, further comprising a release layer applied to said adhesive layer.

16. The credit card overlay in accordance with claim 14, wherein said rhinestone layer is an array of aligned rhinestones, each of said rhinestones having a selected color.

17. The credit card overlay in accordance with claim 14, wherein said rhinestone layer is in the form of rhinestones arranged in at least one pre-selected pattern.

18. The credit card overlay in accordance with claim 4, in the form of a kit comprising multiple overlay designs, a removal tool, and application instructions.

19. The credit card overlay in accordance with claim 14, in the form of a kit comprising multiple overlay designs, a removal tool, and application instructions.
